(19) United States
(12) Patent Application Publication
(10) Pub. No.: US 2012/0055985 A1
(43) Pub. Date: Mar. 8, 2012

(54) ELECTRONIC LABELING SYSTEM

(76) Inventor: Frank Andrew Allen, Dayton, OH (US)

(21) Appl. No.: 13/040,974

(22) Filed: Mar. 4, 2011

Related U.S. Application Data
(60) Provisional application No. 61/310,673, filed on Mar. 4, 2010.

(51) Int. Cl. G06F 17/40

(52) U.S. Cl. 235/375

(57) ABSTRACT

An electronic labeling system is disclosed. The system uses identification and tracking information to provide security control over the merchandise, to issue pricing updates to the labels, to generate targeted marketing campaigns, and/or to perform various reporting functions.

### CROSS-REFERENCE TO RELATED APPLICATIONS

This application claims the benefit of priority to U.S. Provisional Patent Application No. 61/310,673.

### TECHNICAL FIELD

Embodiments of the present disclosure relate generally to an electronic labeling system, and particularly to a system that uses a low power electronic shelf label that receives wireless power and operating instructions.

### BACKGROUND

Merchandise in a retail store is typically indicated with pricing information of various sorts, from price tags attached to the merchandise, to tags affixed to shelves or gondolas on which the merchandise sits, to promotional or in-store marketing in the form of signage concerning sales or discounts on certain items.

### SUMMARY

It is against the above background that embodiments of the present disclosure present an electronic labeling system that uses electronic labels to identify and track merchandise in, for example, a retail location. According to some embodiments, the identification and tracking of the merchandise can be used by the system to provide security control over the merchandise, to issue pricing updates to the labels, to generate targeted marketing campaigns, and to perform various reporting functions.

In one embodiment, an electronic labeling system is disclosed. The labeling system includes an electronic label having an antenna, a power harvester, an interface and a processing circuit configured to control the interface using commands received by the antenna. The labeling system also includes an RFID reader configured to receive and transmit radio frequency waves between the reader and the label. The labeling system further includes a server having a processor, and a non-transitory memory, wherein the memory stores instructions that, when executed by the processor, cause the processor to: receive identification information from the label via the reader, store location information indicative of the location of the label, and provide an interface command to the label via the RFID reader. The processing circuit of the label also updates the interface in response to receiving the interface command.

### BRIEF DESCRIPTION OF THE FIGURES

The following detailed description of the embodiments of the present disclosure can best be understood when read in conjunction with the following drawings, where like structure is indicated with like reference numerals.

FIG. 1 is an illustration of an electronic label attached to a piece of merchandise, according to embodiments shown and described herein.

FIG. 2 is an illustration of an electronic labeling system, according to embodiments shown and described herein.

FIG. 3 is a schematic illustration of an electronic label, according to embodiments shown and described herein.

FIG. 4 is a circuit diagram of an electronic label, according to embodiments shown and described herein.

FIG. 5 is a schematic illustration of a server for an electronic labeling system, according to embodiments shown and described herein.

### DETAILED DESCRIPTION

The present disclosure will be described below relative to various illustrative embodiments. Those skilled in the art will appreciate that the present disclosures may be implemented in a number of different applications and embodiments and is not specifically limited in its application to the particular embodiments depicted herein. In particular, the present disclosures will be discussed below in connection with a retail store using electronic labels and displays, although those of ordinary skill will recognize that the present disclosures could be modified to be used with other types of product tracking environments, such as a warehouse.

As the inventors of the present disclosure have found, changing the various labels and displays in a retail store consumes a great deal of time and money, especially if part of the retail enterprise's business involves constant and frequent price changes due to discounting or other business practices. Additionally, providing as much information to a consumer in as clear a form as possible may be of benefit to the retailer. As the retail industry becomes more and more technology-driven, it has become more important than ever to allow for new systems to be adopted and integrated into a retailer's business in a low-cost manner and as seamlessly as possible. Cost savings to the retailer may then be passed on to the consumer, giving the retailer a competitive advantage in the marketplace.

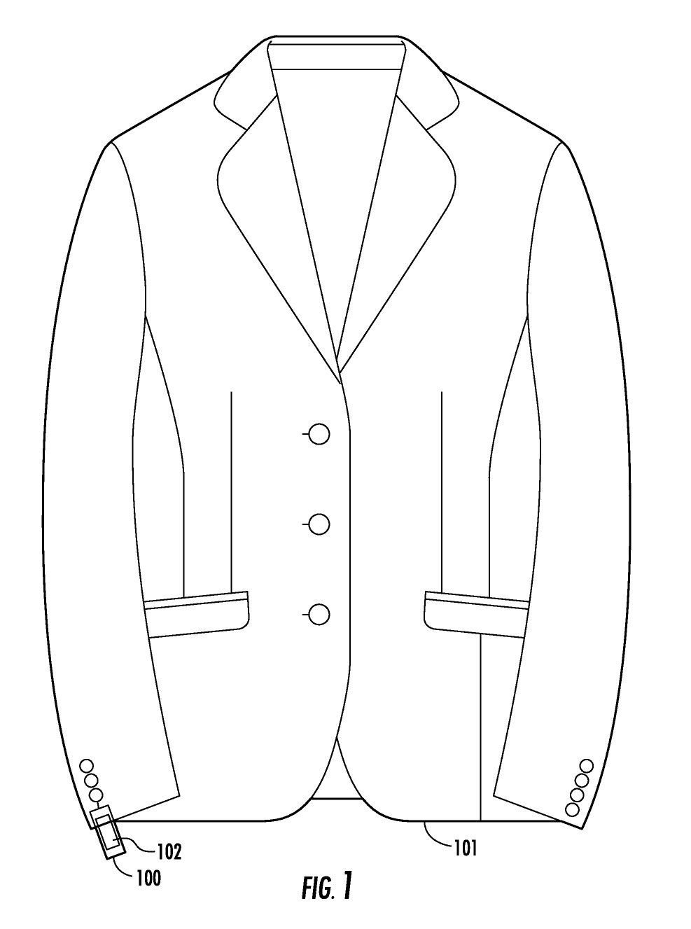

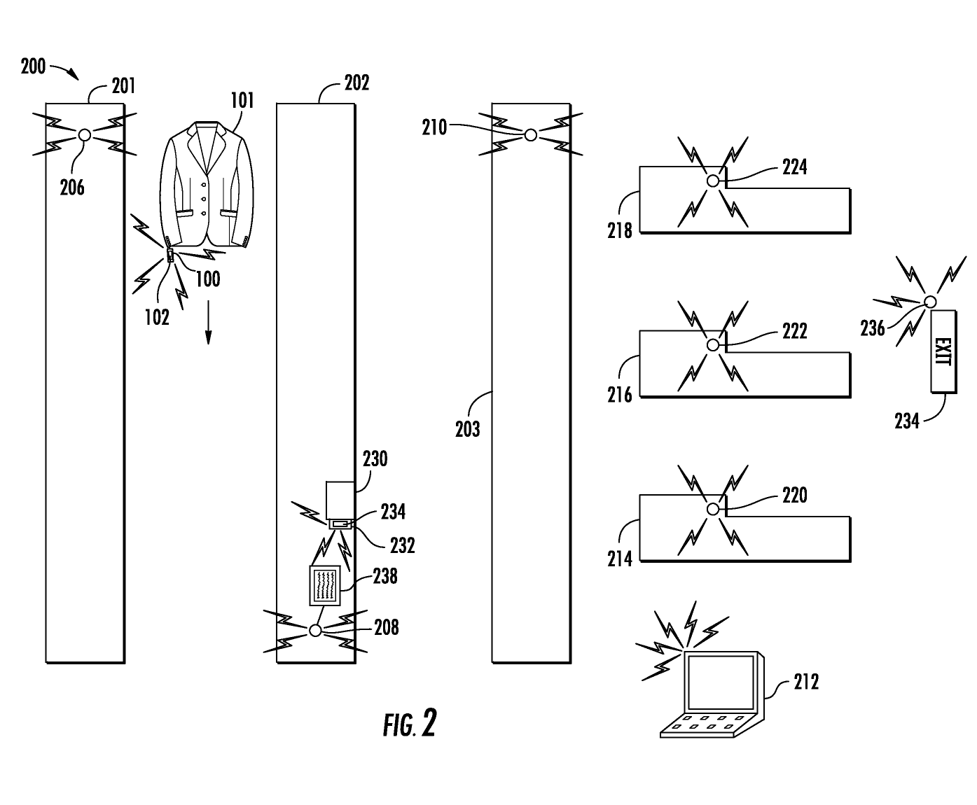

Referring now to FIG. 1, electronic label 100 is shown attached to merchandise 101, according to an exemplary embodiment. Label 100 is configured to provide information to a user via electronic interface 102 (e.g., an electronic display, a speaker, etc.). Label 100 is also configured to send and receive wireless transmissions using radio frequencies and may operate as a tag in radio frequency identification (RFID) systems. In some embodiments, label 100 may also receive power wirelessly using the received radio waves.

Label 100 identifies merchandise 101 by storing one or more codes within its memory. In some embodiments, an electronic product code (EPC) is stored in the memory of label 100 that conforms to one of the various EPC standards (e.g., EPC Generation-2, etc.), for the purpose of identifying merchandise 101 to other devices. In addition to identifying merchandise 101 to other devices, the EPC may also be used to track the location of merchandise 101 as it moves from being in proximity to one RFID reader to being in proximity to another reader.

Label 100 also includes interface 102, which may convey information about merchandise 101 to a user. Interface 102 may be an electronic display and/or a speaker that provides visual and/or audio information about merchandise 101. In some embodiments, label 100 may wirelessly receive commands from other computing devices and provide different information to interface 102 based on the commands that are received. For example, interface 102 may display indicia of the current price of merchandise 101, which may be updated via wireless commands received by label 100. In other embodiments, interface 102 may be separate from label 102 (e.g., a display or speaker mounted near merchandise 101).

Referring now to FIG. 2, electronic labeling system 200 is shown, according to an exemplary embodiment. As shown, electronic labeling system 200 is used in a retail application. However, other embodiments are also contemplated. Electronic labeling system 200 may be adapted for use in other environments, such as an amphitheatre, a warehouse, or any other environment that requires the identification and tracking of merchandise.

Electronic labeling system 200 is shown to include server 212, which provides control over aisle RFID readers 206, 208, 210, check-out RFID readers 220, 222, 224, and exit RFID reader 236. Server 212 receives information read by the RFID readers and may communicate with the RFID readers using hardwired connections (e.g., Ethernet, RS-232, etc.), wireless connections (e.g., WiFi, cellular, etc.), or a combination thereof. In some embodiments, server 212 may also include data storage and mining features that allow information about tracked information to be reported in the aggregate. For example, if server 212 receives location information from aisle readers 206, 208, and 210, server 212 may store this information and produce reports about the movement of products throughout the store.

### Security and Tracking

As merchandise 101 comes within proximity of aisle RFID reader 206, label 100 may receive wireless power and/or a query for EPC or other identifying information from aisle RFID reader 206. In response to receiving wireless signals from aisle RFID reader 206, label 100 may provide the EPC or other identifying information to aisle RFID reader 206 that identifies merchandise 101. Aisle RFID reader 206 relays the identification information to server 212, which may associate the EPC or other identifying information with the location of aisle RFID reader 206 and/or a time stamp (e.g., date, time, etc.). In some embodiments, the location of aisle RFID reader 206 is pre-stored within the memory of server 212 as part of the setup of electronic labeling system 200. In other embodiments, aisle RFID readers 206, 208, and 210 may determine their own locations (e.g., using GPS, triangulation, etc.) and provide their location data to server 212, in addition to the EPC or other identifying information about merchandise 101. If aisle RFID reader 206 provides location data to server 212, the strength of the signal received by aisle RFID reader 206 from label 100 may be used by aisle RFID reader 206 to further limit the range of possible locations of merchandise 101 and used as part of the location data.

When merchandise 101 is moved away from aisle RFID reader 206 and into proximity of RFID reader 208, RFID reader 208 may also wirelessly provide power and/or a query for EPC or other identifying information from label 100. In response to receiving the wireless signals, label 100 may provide the EPC or other identifying information to server 212 via aisle RFID reader 208 to identify and locate merchandise 101.

As merchandise 101 is moved throughout the store, server 212 receives EPC or other identification information from aisle RFID readers 206, 208, and 210. Server 212 may store and aggregate the EPC or other identification information, associated location data, and/or timestamp information. In this way, server 212 may be used for security and tracking purposes. In some embodiments, a user may provide a query to an interface of server 212 for the location, or past locations, of merchandise 101. Server 212, in response to the query, retrieves the information associated with merchandise 101 and provides the information to the interface to convey the information to the user (e.g., as a list, a map showing the movement of merchandise 101, etc.). In other embodiments, server 212 may provide an alert (e.g., an email, indicia on a display, a pager message, an automated phone call, etc.) if the data about merchandise 101 indicates that it is not in an authorized location within the store. For example, expensive merchandise, such as portable electronics, may be stored within a secured display. Server 212 may detect unauthorized movement of the secured merchandise and automatically generate an alert about the movement.

Exit RFID reader 236 may be located at or near exit 234 to further enhance the merchandise tracking and security functions of electronic label system 200. Exit 234 may be any form of boundary that can be used to egress the building (e.g., a window, a door, a ventilation shaft, etc.). Exit RFID reader 236 may operate similarly to aisle RFID reader 206 by providing and receiving similar wireless signals to and from label 100 when merchandise 101 is within proximity of exit RFID reader 236. Exit RFID reader 236 also provides identification and/or location data about merchandise 101 to server 212. In response to receiving the identification and location data from exit RFID reader 236 about merchandise 101, server 212 automatically provides an alert (e.g., an email, indicia on a display, a pager message, an automated phone call, etc.) that merchandise 101 is being moved outside of the building.

Check-out RFID readers 220, 222, and 224 may be located at check-out kiosks 214, 216, and 218, respectively. Check-out RFID readers 220, 222, and 224 send power and/or commands to label 100, when merchandise 101 is within proximity. In response to the received signals, label 100 provides identification, location, and/or other data to check-out RFID readers 220, 222, or 224, which relay the data to server 212. Check-out RFID readers may also be coupled to one or more payment devices (e.g., a cash register, a credit card reader, etc.) and also relay payment information received from a payment device to server 212. In response to receiving payment data for merchandise 101, server 212 provides authorization data to label 100. In some embodiments, label 100 uses the authorization data to deactivate itself or change a configuration setting to indicate that merchandise 101 has been authorized to leave the store. In other embodiments, label 100 may include an electro-mechanical locking mechanism that attaches label 100 to merchandise 101. In this case, label 100 may disengage the locking mechanism, in response to receiving the authorization data.

### In-Store Marketing

In addition to providing tracking and security functions, electronic labeling system 200 may also be used to provide in-store marketing to consumers. Label 100 may receive pricing or other data from server 212 and provide the data to interface 102 via aisle RFID reader 206 to convey the data to the consumer. For example, if merchandise 101 is on sale, interface 102 may provide indicia that the price of merchandise 101 has been reduced (e.g., as a percentage, indicia showing the original and current price, etc.). In another example, server 212 may provide visual and/or audio alerts to the consumer via interface 102 when a price change goes into effect (e.g., as a temporary promotion, etc.). Similarly, server 212 may also provide product information to interface 102 about merchandise 101 or similar products. For example, if merchandise 101 is a sport coat, interface 102 may display marketing information about a matching shirt (e.g., directing the consumer to the location of the shirt, offering a sale price if the shirt is also purchased, etc.). In another example, interface 102 may display information about the sport coat that may be of general interest to the consumer (e.g., size, fabric, etc.). In this way, the consumer may not have to take the sport coat off of a rack or unfold it to find the same information on a tag sewn to the coat, making the buying process easier for the consumer and reducing manpower requirements for the seller (e.g., to refold an article of clothing, to return a product to a display, etc.).

Electronic labeling system 200 also includes a display 238 which is in communication with aisle RFID reader 208. As merchandise 101 comes within proximity of aisle RFID reader 208, server 212 may use the identification and location data about merchandise 101 to provide information about products that may also be of interest to the consumer near display 238. For example, if merchandise 101 is a jar of peanut butter, as label 100 is brought within proximity of aisle RFID reader 208, server 212 may provide an advertisement for jelly to display 238. The advertisement may, for example, include a discount when the peanut butter and jelly are purchased together.

In some embodiments, a label may not be physically attached to a piece of merchandise, but may instead be located near the product. For example, merchandise 230 may be located on a shelf or other form of retail display that includes one or more of a particular type of product. Static label 232 may be located near merchandise 230 (e.g., adhered to the shelf, placed on the shelf, etc.), but not physically attached to any of merchandise 230. Aisle RFID reader 208 may interact with static label 232 in a similar manner as label 100 to determine the identity and location of merchandise 230. Server 212 uses the identification and/or location data for merchandise 230 to determine and provide marketing data to display 238 and/or to interface 234 (e.g., a display, speaker, etc.) of static label 232. For example, if merchandise 230 includes jars of peanut butter, display 238 may display an advertisement for the brand of peanut butter and/or sale information about the peanut butter. Where multiple static labels are within proximity of aisle RFID reader 208, server 212 may periodically update the display to show advertisements for their associated products. For example, if static labels for peanut butter and jelly are within proximity of aisle RFID reader 208, server 212 may cause display 238 to show an advertisement for peanut butter followed by an advertisement for jelly. In other embodiments, the merchandise 230 may also include an attached label (not shown, but similar to label 100), as well as being associated with static label 232.

While server 212 is depicted as a single computing device, it is to be understood that this is exemplary only. More specifically, server 212 may represent a plurality of computers, servers, databases, etc., or other forms of computing devices that provide control over the RFID readers, electronic labels, and displays of electronic labeling system 200.

### Reporting

In addition to actively providing security and marketing functionality, server 212 may also use the tracked locations of merchandise 101 to generate various reports of interest to the retailer. For example, if a majority of consumers move merchandise 101 directly to check-out kiosk 224, this may indicate that most consumers are making target purchases of merchandise 101 (e.g., they went to the store to specifically purchase merchandise 101). This may be the case where merchandise 101 is an expensive item or a consumable good (e.g., a medication, toiletry, etc.). Where merchandise 101 is not in these product categories, it may also mean that the initial location of merchandise 101 within the store is not within proximity of related goods that may also be of interest to a consumer. For example, a purchaser of peanut butter may be more likely to also purchase jelly if the jelly is located near the peanut butter in the store. In some embodiments, server 212 may also generate reports on a collection of products that are purchased together and used to locate these products near each other within the store.

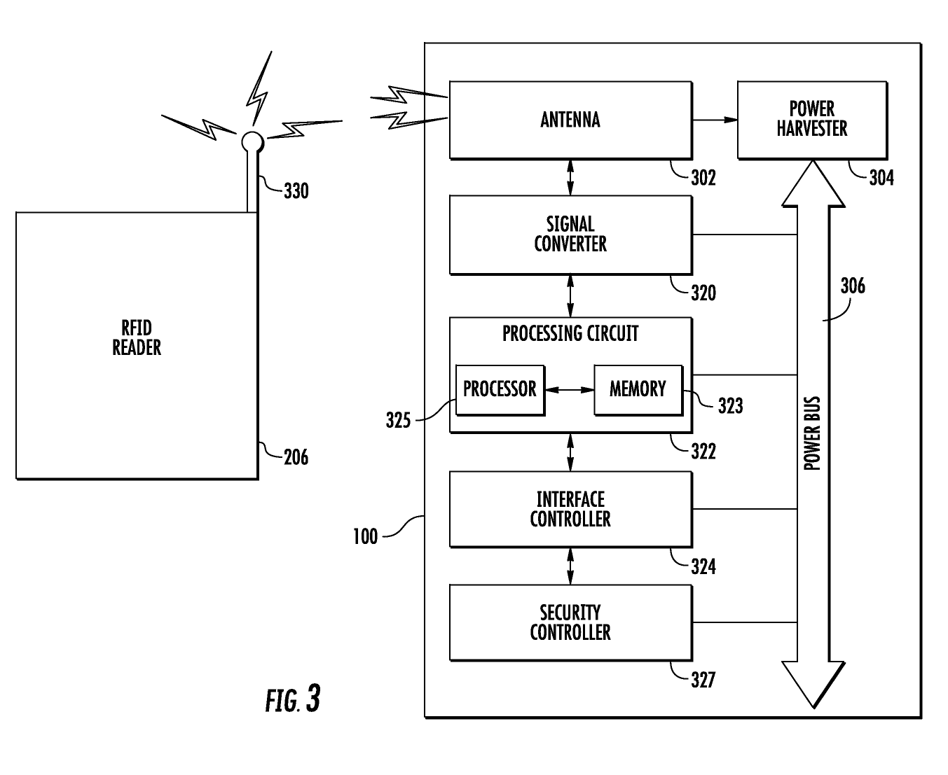

Referring now to FIG. 3, a schematic illustration of label 100 is shown, according to an exemplary embodiment. Label 100 communicates wirelessly with RFID readers, e.g., aisle RFID reader 206, as part of electronic labeling system 200. Aisle RFID reader 206 includes one or more antennas 330 which transmit and receive wireless signals to and from label 100 and server 212. Although a single antenna is depicted, it is to be understood that antenna 330 may include any number of antennas that operate on different frequencies. For example, antennas 330 may include a WiFi antenna operating at a 2.4 GHz frequency and a radio-frequency antenna that operates in the 860-960 MHz range. Any number of frequency ranges may be utilized, without deviating from the present disclosure.

Label 100 includes antenna 302 which receives and transmits radio signals to and from aisle RFID reader 206. In some embodiments, antenna 302 operates in the 860-960 MHz range as specified in the EPC Generation 2 standard. In other embodiments, antenna 302 may operate in other frequency ranges. Antenna 302 may be either internal to the housing of label 100 (not shown) or internal. When antenna 302 receives wireless signals from aisle RFID reader 206 or other sources (e.g., checkout RFID reader 220, exit RFID reader 236, etc.), antenna 302 converts the wireless signals to electronic signals.

Power harvester 304 receives the electronic signals generated by antenna 302 and converts them to power for use by label 100. In this way, power harvester 304 can harvest power from transmissions between other devices in electronic labeling system 200, ambient radio frequency waves in the air, and from other sources. In some embodiments, power harvester 304 is the only source of power for label 100, thereby eliminating the need for other power sources (e.g., a battery, an ultra-capacitor, a wall socket, etc.). Power harvester 304 provides the harvested power to power bus 306, which provides power to the other components of label 100 (e.g., signal converter 320, processing circuit 322, interface controller 324, etc.). In some embodiments, RFID reader 206 may also include a power harvester circuit that receives electronic signals generated by antenna 330.

Antenna 302 also provides the electronic signals to signal converter 320, which processes the signals into a digital formal. Signal converter 320 may include demodulation, digital sampling, and other circuitry to convert the electronic signals into a data format usable by processing circuit 322. Signal converter 320 may also include modulation and control circuitry to control antenna 302 when signals are transmitted from label 100 to aisle RFID reader 206 using data provided by processing circuit 322.

Label 100 also includes processing circuit 322, which receives and provides data to and from signal converter 320. Processing circuit 322 includes processor 325, which is in communication with memory 322. Processing circuit 322 may be a single microcontroller, an application specific integrated circuit (ASIC), or any other electronic circuit capable of storing and processing data. In some embodiments, processing circuit 322 may operate in low power conditions, in order to allow power harvester 304 to be used as the only power source in label 100. For example, the ultra-low power MSP430 family of microcontrollers by Texas Instruments, Inc.™ may be used for processing circuit 322, according to some embodiments.

Memory 323 may be any form or combination of memory devices (e.g., RAM, flash memory, ROM, non-transitory memory, etc.). Memory 323 is communicatively coupled to processor 325 and may store instructions that, when executed by the processor 325, cause processor 325 to perform one or more of the functions disclosed herein. Memory 323 also includes product identification information for the merchandise associated with label 100. For example, memory 323 may store one or more EPC codes that identify a piece of merchandise.

Processor 325 receives requests for identification information from RFID reader 206 via antenna 302 and signal converter 320 and retrieves the corresponding information from memory 325. Processor 325 then provides the identification information to signal converter 320 for broadcasting to aisle RFID reader 206 via antenna 302. In addition to receiving requests for identification information, processor 325 may also receive one or more operating commands from aisle RFID reader 206. Operating commands may include, but are not limited to, commands to convey information via interface 102 and to enable or disable security features of label 100. For example, processor 325 may receive a command to change pricing information conveyed by interface 102.

Interface controller 324 provides control over interface 102 (e.g., a display and/or a speaker). Interface controller 324 receives data from processing circuit 322 to convey different information to a user via interface 102 based on the data. For example, interface controller 324 may update a display of interface 102 to show the current price of the merchandise associated with label 100. In another example, interface controller 324 may cause interface 102 to provide audio information about related products, as label 100 is moved throughout a store.

In some embodiments, label 100 may also include security controller 327. Security controller 327 receives commands from processing circuit 322 to enable or disable features of tag 100. For example, security controller 327 may disable label 100 from broadcasting identification information if processing circuit 322 receives information indicative of payment information. If label 100 includes an electro-mechanical locking mechanism that affixes label 100 to a piece of merchandise, security controller 327 may enable or disable the locking mechanism using commands from processing circuit 322.

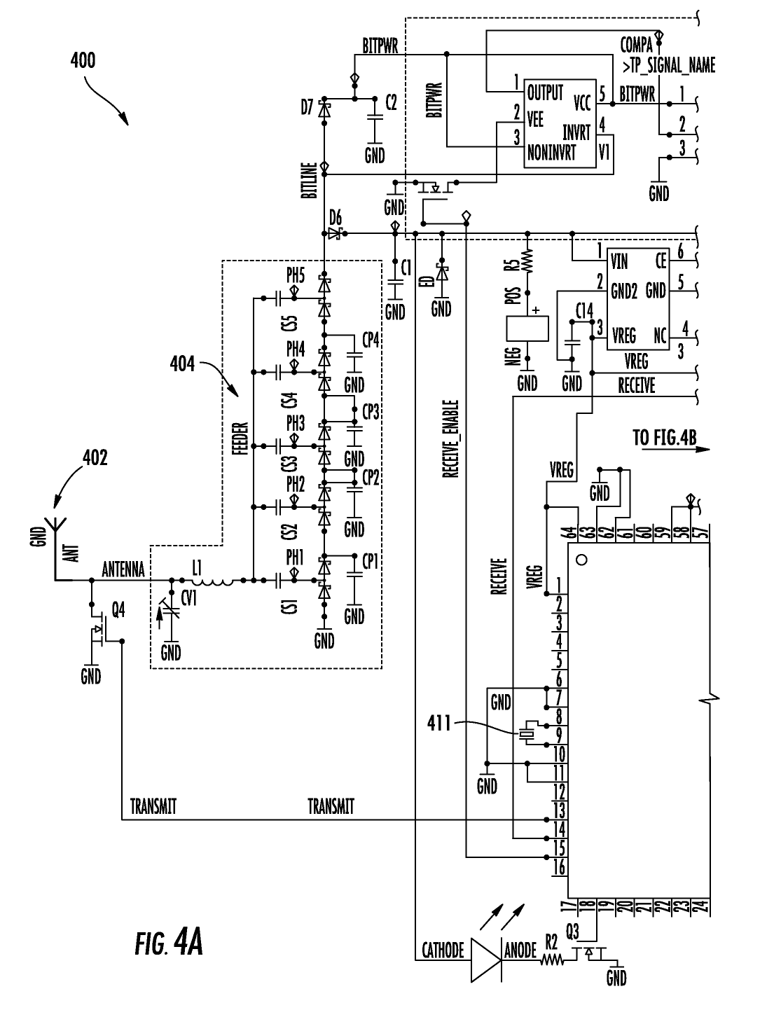

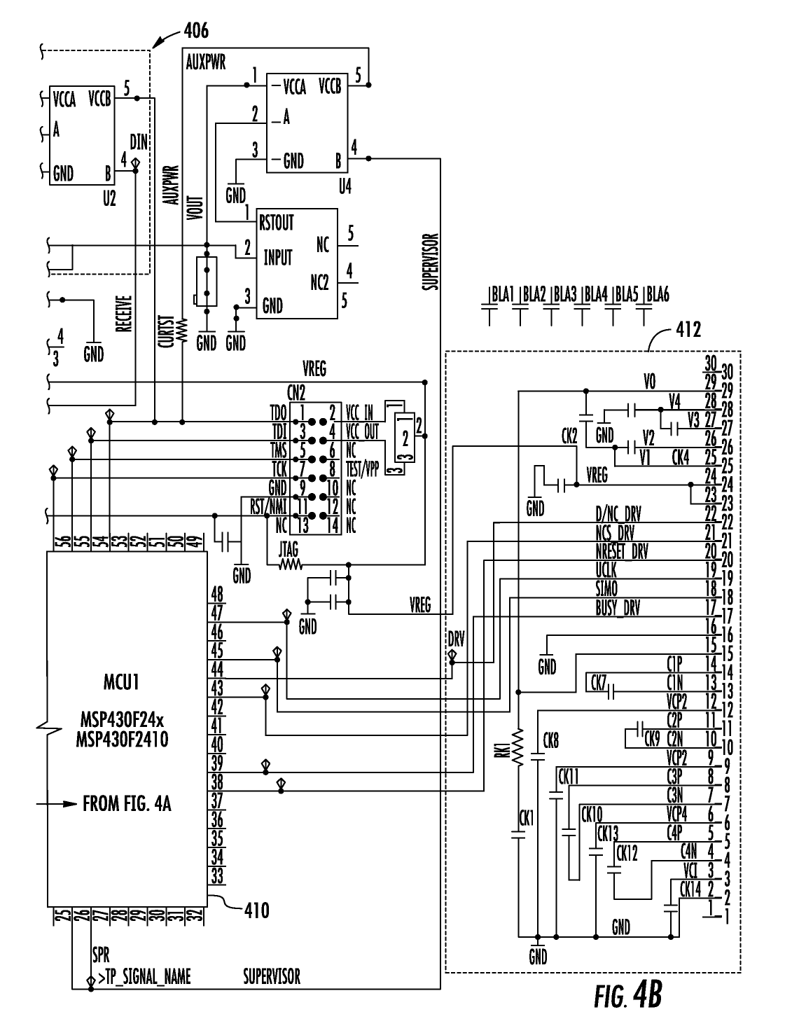

Referring now to FIG. 4, a detailed circuit diagram of an electronic label is shown, according to an exemplary embodiment. Antenna 402 receives and transmits radio frequency waves and communicates with an RFID reader. Received wireless signals are converted by antenna 402 into electronic signals. Power harvester 404 receives the electronic signals from antenna 402 and converts the signals into electronic power for circuit 400. Signal converter 406 receives an enable signal from microcontroller 410, which enables received signals from antenna 402 to be processed by microcontroller 410.

Microcontroller 410 receives commands and identity requests from antenna 402. If microcontroller 410 receives an identity request, microcontroller 410 retrieves the EPC or identifying information from memory and causes antenna 402 to transmit the EPC or other identifying information wirelessly. If microcontroller 410 receives a command to update product information conveyed to a user, microcontroller 410 causes audio interface 411 (e.g., a piezoelectric speaker, etc.) or display controller 412 to provide the updated information to a user. For example, microcontroller 410 may cause a display (not shown) to display pricing information about the merchandise associated with label 400.

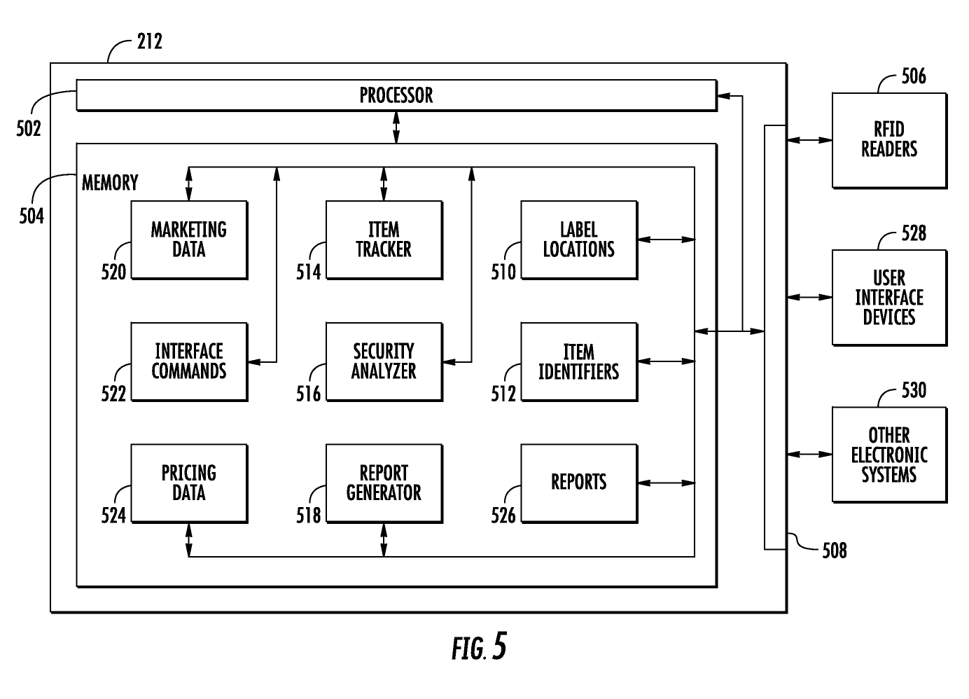

Referring now to FIG. 5, a detailed schematic illustration of server 212 is shown, according to an exemplary embodiment. Server 212 includes processor 502 and memory 504. Processor 502 executes computer-executable program instructions stored in memory 504. In some embodiments, processor 502 may be one or more processors. Such processors may be, but are not limited to, microprocessors, programmable logic controllers (PLCs), ASICs, or state machines. Memory 504 may be any combination of memory devices and/or non-transitory computer readable media. Embodiments of computer-readable media include, but are not limited to, an electronic, optical, magnetic, or other storage or transmission device capable of providing a processor, such as processor 502, with computer-readable instructions. Other examples of suitable media include, but are not limited to, a floppy disk, CD-ROM, DVD, magnetic disk, memory chip, ROM, RAM, all optical media, all magnetic tape or other magnetic media, or any other medium from which a processor 502 can read instructions. Also, various other forms of computer-readable media may transmit or carry instructions to server 212, including a router, private or public network, or other transmission device or channel, both wired and wireless. The instructions may comprise code from any computer-programming language, including, for example, C, C++, C#, Visual Basic, Java, Python, Perl, and JavaScript, and implemented in assembly or machine language, if desired. In any case, the language may be a compiled or interpreted language.

Interface 508 may include any number of internal and external interfaces for server 212. For example, interface 508 may include one or more interfaces for user interfaces devices 528 (e.g., a keypad, a microphone, a touch-screen, or any other form of electronic input device). Interface 508 also include one or more interfaces to communicate with RFID readers 506 (e.g., aisle RFID reader 206, checkout RFID reader 222, exit RFID reader 236, etc.) and other electronic systems 530 (e.g., other servers, computers, cellular phones, handheld devices, cash registers, etc.) over hardwired and/or wireless connections. Any number of combinations of connections may be used to communicate with RFID readers 506, user interface devices 528, and other electronic systems 530. For example, some of the readers in RFID readers 506 may communicate with server 212 over an Ethernet connection, while others communicate with server 212 via a WiFi connection.

Memory 504 is shown to include label locations 510 and item identifiers 512. When an electronic label is within proximity of a reader in RFID readers 506, the reader initiates a query routine that retrieves one or more item identifiers from the label (e.g., EPC data or other identification information). RFID readers 506 communicate the item identification information to server 212 via interface 508 and server 212 stores the identification information as item identifiers 512. In one embodiment, when a label is queried by a reader in RFID readers 506, the RFID reader may also provide location information to server 212 with the item identification information. Server 212 then stores the information as label locations 510. Label locations 510 may include range information indicative of where the label is in relation to the reader, based on the strength of the signals received by the reader. In another embodiment, label locations 510 are pre-stored in server 212 as RFID reader locations. For example, label locations 510 may include the location of aisle RFID reader 206. When server 212 receives item identification information from aisle RFID reader 206, the information from a source label may then be associated with the location of aisle RFID reader 206 in label locations 510. In yet another embodiment, label locations 510 may include GPS information from a source label or an RFID reader. In some embodiments, label locations 510 and/or item identifiers 512 may also include timestamp information (e.g., a time and/or date). In this way, label locations 510 may provide a history of label locations for item identifiers 512.

Item tracker 514 analyzes label locations 510 and item identifiers 512 to determine the current and/or previous locations of a particular item. For example, for a particular item in item identifiers 512, item tracker 514 may retrieve the locations and timestamp data from label locations 510 to determine the history of the item's locations. In some embodiments, item tracker 514 may also use the history of item locations predict future locations for a particular item. For example, location and timestamp information in label locations 510 may indicate that label 100 has moved from being in proximity to aisle RFID reader 206 to being in proximity to aisle RFID reader 210. Item tracker 514 may use linear interpolation, regression, or any other mathematical technique to determine the likely course of travel for label 100.

Security analyzer 516 utilizes item identifiers 512 and label locations 510 to determine if a label is located in a restricted area. For example, if label 100 is within proximity of exit RFID reader 236, this may indicate that a security breach has occurred. In some embodiments, security analyzer 516 may also utilize predicted locations from item tracker 514 to determine the likelihood of a security breach occurring. Security analyzer 516 may also generate security alerts and provide them to user interface devices 526 (e.g., as an alert on an electronic display, as an alarm via a speaker, etc.) and/or to other electronic systems 530 (e.g., as an alert sent to a portable device, etc.).

In some embodiments, security analyzer 516 may receive payment information from other electronic systems 530 (e.g., a cash register, a credit card reader, etc.) and use the payment information to authorize a label to leave a particular location. For example, a cash register located at checkout kiosk 218 may send payment information to server 212 while checkout RFID reader 224 sends identification information from label 100 to server 212. Security analyzer 516 may use the payment information to authorize merchandise 101 to leave the store. In one embodiment, security analyzer 516 may send an unlock command to label 100 to deactivate an electromechanical locking mechanism that attaches label 100 to merchandise 101. In another embodiment, security analyzer 516 sends a command to label 100 via a reader in RFID readers 506 (e.g., checkout RFID reader 224, etc.) that causes label 100 to deactivate its broadcasting of EPC or other identification information. In yet another embodiment, security analyzer 516 uses the payment information to create an exception for label 100. For example, when label 100 later comes within proximity of exit RFID reader 236, security analyzer 516 may not generate a security alert, if an exception exists.

Memory 504 also includes pricing data 524 and interface commands 522. Pricing data 524 is associated with items in item identifiers 512. For example, pricing data 524 may include one or more prices for merchandise 101. Interface commands 522 contain commands for interfaces of electronic labels and/or displays located throughout the building. Commands may include, but are not limited to, commands that cause indicia to be displayed or audio sounds to be produced. For example, interface 102 of label 100 may display a price for merchandise 101. Pricing data 524 may cause interface commands 522 to issue a pricing update command to interface 102 via RFID readers 506 to update the displayed price. In some embodiments, pricing data 524 may also include time information to implement pricing changes. For example, a given sale price may be effective for only a limited period of time. When the sale begins, interface commands 522 issues a pricing update command to reflect the sale price. Once the sale is over, interface commands 522 issues another pricing update command to return the sale price back to the original price.

Memory 504 is also shown to include marketing data 520. Marketing data 520 may include, but is not limited to, sales promotions, advertisements, and other information that may be relevant to a consumer. Interface commands 522 uses item identifiers 512, label locations 510, and marketing data 520 to determine if a marketing update command is necessary. A marketing update command may be necessary, for example, if an electronic label is moved within proximity of a related product (e.g., a jar of peanut butter is moved within proximity of a jar of jelly, etc.). If a marketing update command is necessary, interface commands 522 sends the update command to the label or display using marketing data 520. For example, interface commands 522 may periodically send a marketing update command to update an advertisement displayed on display 238 or interface 102.

Report generator 518 uses item identifiers 512, label locations 510, marketing data 520, pricing data 524 and data from item tracker 514, security analyzer 516 and interface commands 522 to generate reports 526. Reports 526 may be generated automatically, periodically, and/or in response to a report request received by report generator 518 from user interface devices 528 or other electronic systems 530. Reports 526 may include, but are not limited, reports on item movement, sales information for a given product, the effectiveness of a marketing update command, which products are typically purchased together, security reports, or any other type of report relevant to electronic labeling system 200. The generated reports 526 may then be provided to user interface devices 528 (e.g., as a list, pie chart, etc. on a display, etc.) or to other electronic systems 530.

In one embodiment, report generator 518 may receive information from interface commands 522 and item tracker 514 to determine the effectiveness of the marketing update command. For example, a marketing update command may include a promotional price for a jar of jelly and is sent by interface commands 522 when a jar of peanut butter is brought within proximity of the jar of jelly. If, shortly after the marketing update command is sent, item tracker 514 detects movement of the jar of jelly, this may indicate that the marketing was effective.

In another embodiment, reports 526 may also include security reports using information received from security analyzer 516. The security reports may indicate, for example, how frequently a product is stolen, the original location of the stolen products, the frequency of thefts as a function of time, etc., or any other security information that may be used to track and prevent thefts. For example a security report may indicate that smaller products originally located near exit 234 are more likely to be stolen than larger products. Such a report may be used by a security expert to determine optimal locations for merchandise within the store or determine which areas of the store may need added security.

In yet another embodiment, reports 526 may also include shopping pattern reports on how consumers interact with the different merchandise located throughout the store. For example, a shopping report may indicate that merchandise located near aisle RFID reader 206 is more likely to be purchased than merchandise located near aisle RFID reader 208. Such reports may be used to determine optimal locations throughout the store where merchandise may be sold.

Thus, by the above disclosure, embodiments concerning an electronic labeling system for identifying and tracking merchandise are disclosed. One skilled in the art will appreciate that the teachings can be practiced with embodiments other than those disclosed. The disclosed embodiments are presented for purposes of illustration and not limitation, and the invention is only limited by the claims that follow. For example, the methods and systems described here are not limited to any particular hardware or software configuration, or to any particular communications modality, but rather they may find applicability in any communications or computer network environment.

Many modifications and variations of embodiments of the present disclosure are possible in light of the above description. The above-described embodiments of the various systems may be used alone or in any combination thereof without departing from the scope of the disclosure. Although the description and figures may show a specific ordering of steps, it is to be understood that different orderings of the steps are also contemplated in the present disclosure. Likewise, one or more steps may be performed concurrently or partially concurrently.

What is claimed is:

1. An electronic labeling system comprising:
an electronic label comprising an antenna, a power harvester, an interface and a processing circuit configured to control the interface using commands received by the antenna;
an RFID reader configured to receive and transmit radio frequency waves between the reader and the label; and
a server comprising a processor, and a non-transitory memory, wherein the memory stores instructions that, when executed by the processor, cause the processor to:
receive identification information from the label via the reader,
store location information indicative of the location of the label, and
provide an interface command to the label via the RFID reader; and
wherein the processing circuit updates the interface in response to receiving the interface command.
